(19) United States
(12) Patent Application Publication
(10) Pub. No.: US 2026/0046166 A1
(43) Pub. Date: Feb. 12, 2026

(54) Dynamic Resource Configuration in a Physical Uplink Control Channel

(71) Applicant: Dell Products L.P., Round Rock, TX (US)

(72) Inventors: Eran Goldstein, Montreal (CA); Masoud Ebrahimi Tazeh Mahalleh, Kanata (CA); Wei Chu, Lachine (CA)

(21) Appl. No.: 18/796,174

(22) Filed: Aug. 6, 2024

(51) Int. Cl. H04L 25/02

(52) U.S. Cl. CPC H04L 25/0204

(57) ABSTRACT

A system can utilize a first common physical uplink control channel (PUCCH) format 1 communication format for broadband cellular communications with user equipment via a channel. The system can estimate a first channel characteristic based on performing channel estimation on the channel over uplink signals, which comprises a Doppler spread. The system can estimate a second channel characteristic based on the performing of the channel estimation over uplink signals, which comprises a delay spread. The system can determine a number of symbols for a second common PUCCH format 1 communication format with the user equipment based on the first channel characteristic. The system can determine a group of initial cyclic shift indices for the second common PUCCH format 1 communication format with the user equipment based on the second channel characteristic. The system can communicate with the user equipment according to the second common PUCCH format 1 communication format.

### BACKGROUND

Broadband cellular networks can facilitate network communications with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can utilize a first common physical uplink control channel format 1 communication format for broadband cellular communications with user equipment via a channel. The system can estimate a first channel characteristic based on performing channel estimation on the channel over uplink signals, wherein the first channel characteristic comprises a Doppler spread. The system can estimate a second channel characteristic based on the performing of the channel estimation over uplink signals, wherein the second channel characteristic comprises a delay spread. The system can determine a number of symbols for a second common physical uplink control channel format 1 communication format with the user equipment based on the first channel characteristic. The system can determine a group of initial cyclic shift indices for the second common physical uplink control channel format 1 communication format with the user equipment based on the second channel characteristic. The system can communicate with the user equipment according to the second common physical uplink control channel format 1 communication format.

An example method can comprise utilizing, by a system comprising at least one processor, a first common physical uplink control channel format 1 communication format for broadband cellular communications with user equipment via a channel. The method can further comprise estimating, by the system, a Doppler spread and a delay spread based on a result from a channel estimation for the channel over uplink signals. The method can further comprise determining, by the system, a number of symbols and a group of initial cyclic shift indices for a second common physical uplink control channel format 1 communication format with the user equipment based on the Doppler spread and the delay spread. The method can further comprise communicating, by the system, with the user equipment according to the second common physical uplink control channel format 1 communication format.

An example non-transitory computer-readable medium can comprise instructions that, in response to execution, cause a system comprising a processor to perform operations. These operations can comprise utilizing a first common physical uplink control channel communication format for broadband cellular communications with user equipment, wherein the first common physical uplink control channel communication format is configured for reception of hybrid automatic repeat request information and scheduling requests from the user equipment. These operations can further comprise estimating a Doppler spread and a delay spread based on performing channel estimation over uplink signals. These operations can comprise determining a number of symbols and a group of initial cyclic shift indices for a second common physical uplink control channel communication format with the user equipment based on the Doppler spread and the delay spread, wherein the second common physical uplink control channel communication format is configured for reception of the hybrid automatic repeat request information and the scheduling requests from the user equipment. These operations can comprise communicating with the user equipment according to the second common physical uplink control channel communication format.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate dynamic resource configuration in PUCCH, in accordance with an embodiment of this disclosure;

FIG. 2 illustrates an example process flow for determining initial cyclic shift (CS) indices in common PUCCH, and that can facilitate dynamic resource configuration in PUCCH, in accordance with an embodiment of this disclosure;

FIG. 3 illustrates an example process flow for determining a number of symbols in common PUCCH, and that can facilitate dynamic resource configuration in PUCCH, in accordance with an embodiment of this disclosure;

FIG. 4 illustrates an example table that can facilitate dynamic resource configuration in PUCCH, in accordance with an embodiment of this disclosure;

FIG. 5 illustrates an example process flow for determining CS indices in dedicated PUCCH, and that can facilitate dynamic resource configuration in PUCCH, in accordance with an embodiment of this disclosure;

FIG. 6 illustrates an example process flow for determining a number of symbols in dedicated PUCCH, and that can facilitate dynamic resource configuration in PUCCH, in accordance with an embodiment of this disclosure;

FIG. 7 illustrates an example process flow 700 for determining an orthogonal cover code (OCC) in dedicated PUCCH, and that can facilitate dynamic resource configuration in PUCCH, in accordance with an embodiment of this disclosure;

FIG. 8 illustrates an example process flow that can facilitate dynamic resource configuration in PUCCH, in accordance with an embodiment of this disclosure;

FIG. 9 illustrates another example process flow that can facilitate dynamic resource configuration in PUCCH, in accordance with an embodiment of this disclosure;

FIG. 10 illustrates another example process flow that can facilitate dynamic resource configuration in PUCCH, in accordance with an embodiment of this disclosure; and

FIG. 11 illustrates an example block diagram of a computer operable to execute an embodiment of this disclosure.

### DETAILED DESCRIPTION

### Overview

The examples herein generally relate to fifth generation new radio (5G NR) broadband cellular communications. It can be appreciated that they can be applied to other types of broadband cellular communications, such as sixth generation (6G) technologies, and more generally to wireless communications.

Physical uplink control channel (PUCCH) format 1 (F1) can be used for transmission of hybrid automatic repeat request (HARQ) information and scheduling request (SR) from user equipment (UEs) to a gNodeB (gNB, which can generally comprise a base station). The design of PUCCH F1 can allow for multiple UEs to use the same time (orthogonal frequency division multiplexing (OFDM) symbols) and frequency (resource block (RB)) resources. The UEs can be multiplexed using orthogonal sequences that spread the signal across time and frequency. Each UE can be assigned a cyclic shift (CS) of a base constant amplitude zero autocorrection (CAZAC) sequence and a Walsh code, which can be known as an orthogonal cover code (OCC). The CAZAC sequence can spread the signal across frequency and the OCC can spread it across time. The set of CSs and OCCs can collectively be called orthogonal resources.

PUCCH F1 can generally comprise a symbol length of 4-14, a number of bits<=2, be referred to as “long PUCCH,” have multiplexing of 36 to 84s in the same physical resource block (PRB), and use time multiplexing in uplink control information (UCI) and demodulation reference signals (DMRS).

Under ideal conditions, for example no delay spread, no doppler frequency, and no time misalignment, CS sequences as well as OCCs can be perfectly orthogonal. Hence, PUCCH transmissions from different UEs can be separated at the receiver without any interference between UEs. However, when the conditions are not ideal, orthogonality can be broken. For example, if the UEs are not time aligned or if the channel has delay spread, there can be some leakage across the CS sequences, causing performance degradation. Also, in the presence of doppler frequency, the channel can be time varying, causing OCCs to lose orthogonality, and resulting in interference between them.

As discussed, under non-ideal conditions, the cross correlation between orthogonal sequences is not zero. However, some pairs of orthogonal sequences can have smaller cross correlations than other pairs. The present techniques can improve receiver performance by dynamically selecting the orthogonal sequences for UEs in such a way that those orthogonal sequences with smaller cross correlations are prioritized in being assigned to the UEs. The selection of the resources can be based on channel characteristics learned by a base-station. These characteristics can include average delay spread or average doppler frequency of all UEs to be scheduled. These characteristics can also include separate parameters for each UE.

For example, if the average delay spread of the UE channels to base-station is large, or if there are significant time advances, the UEs can be assigned CS sequences that are as far apart as possible.

On the other hand, if the doppler frequency is high, inter-UE interference can be reduced by configuring PUCCH with a smaller number of OFDM symbols. Hence, shorter length OCCs can be required, which in turn, can lead to lower interference when the channel is time varying. It can be that further improvement can be achieved if each CS sequence or OCC is used as few times as possible (or a suitably small number of times). In other words, a CS/OCC can be used more than once only if the number of UEs exceed the number of selected CSs/OCCs.

Regarding a CAZAC sequence, there can be 12 cyclic shifts of the same base CAZAC sequence of length 12, which are all orthogonal to each other if the channel is single-path and there is no time mis-alignment among the UEs. In a multipath channel or with time mis-alignment, it can be that these cyclic shifts are not completely orthogonal anymore causing interference among UEs. It can be that larger the separation between two cyclic shifts, the more robust they are to non-orthogonality caused by multipath or time mis-alignment. Hence, there can be approaches to only use a subset of the cyclic shifts such that the minimum separation between any two cyclic shifts is a certain value larger than 1. This minimum cyclic shift separation can be denoted by ΔC. For example, ΔCS=2 indicates that either the subset {0,2,4,6,8,10} or the subset {1,3,5,7,9,11} of all cyclic shifts can be used. The set of CSs and OCCs can collectively be called orthogonal resources.

In general, a loss of orthogonality can degrade detection (and demodulation) in three ways: interference, loss of coherent integration, and noise estimation. Noise estimation can be crucial for reducing false alarm cases of noise getting interpreted as a real signal, and can normally be measured over unused OCC+CS resources. The leakage of signal energy from a used resource to an unused resource can degrade the noise estimation. Likewise, the loss of orthogonality can degrade signal quality after coherent summation where the coherency is not kept.

With regard to parameters that can be utilized by the present techniques, for example, for a macro cell in urban area, a delay spread is large. Or a cell covering a highway can be expected to have UEs with large doppler frequency.

A learning stage of estimating channel characteristics can be implemented as follows. The present techniques can generally utilize two estimated channel characteristics: average Doppler spread and average delay spread. The cell can therefore start with a default, or a baseline, PUCCH configuration, and can estimate these two values by performing channel estimation over various UL signals such as PUCCH, physical uplink shared channel (PUSCH) (demodulation reference signal (DMRS)), and sounding reference signal (SRS), or others.

In some examples, an estimation stage can be one time stage. In other examples, the estimation stage can be an on-going one. A cell can re-estimate the channel average characteristics, and apply a new PUCCH configuration (as described below) for each configured time T, where a value of T can be configured.

In prior approaches, cells' PUCCH resources can be configured as part of cell planning, and not in a dynamic data-based approach.

The present techniques can be implemented to improve level 1 (L1; physical layer) and/or L2 (data link layer) layers of a gNB. For example, a system comprising a radio unit (RUs)/a distributed unit (DU) (L1, L2, level 3 (L3; network layer))/central unit (CU) can benefit from the present techniques, through improved coverage/throughput and reduced RU power consumption both at the UE side and the network side.

### Example Architectures, Process Flows, and Tables

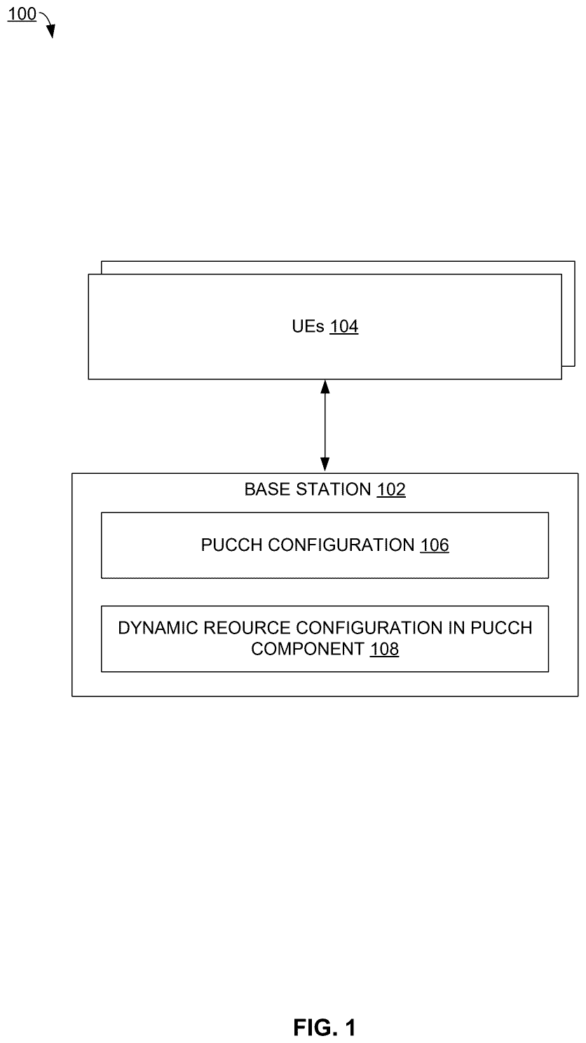

FIG. 1 illustrates an example system architecture 100 that can facilitate dynamic resource configuration in PUCCH, in accordance with an embodiment of this disclosure.

System architecture 100 comprises base station 102 and UEs 104. In turn, base station 102 comprises PUCCH configuration 106 and dynamic resource configuration in PUCCH component 108.

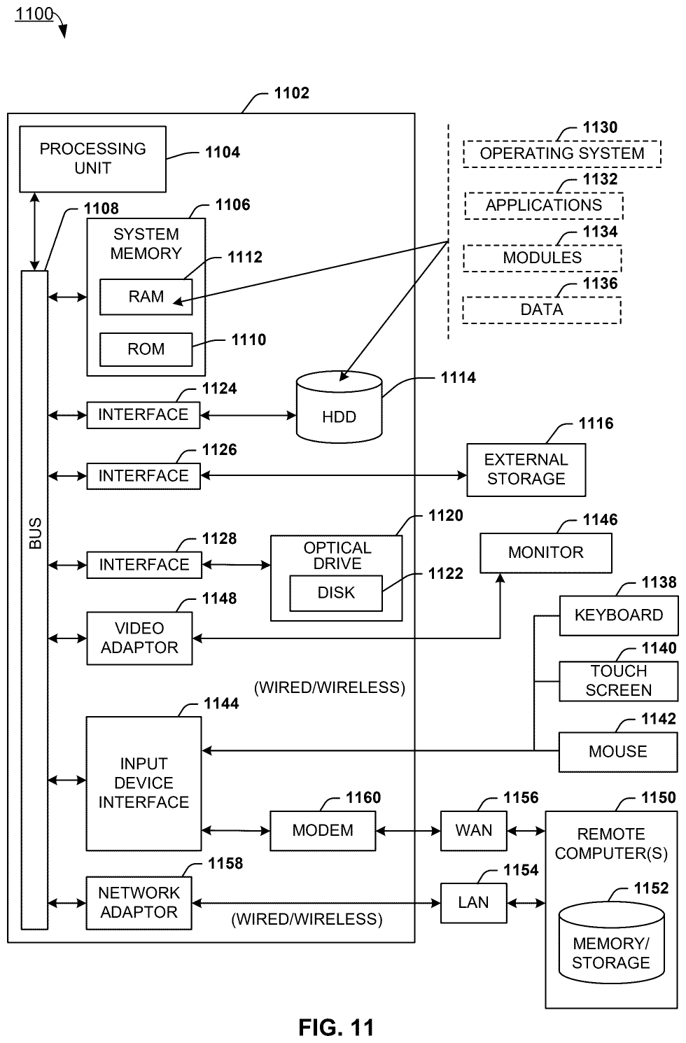

Each of base station 102 and/or UEs 104 can be implemented with part(s) of computing environment 1100 of FIG. 11.

Dynamic resource configuration in PUCCH component 108 can identify a PUCCH configuration (e.g., PUCCH configuration 106) to use when communicating with one or more UEs of UEs 104.

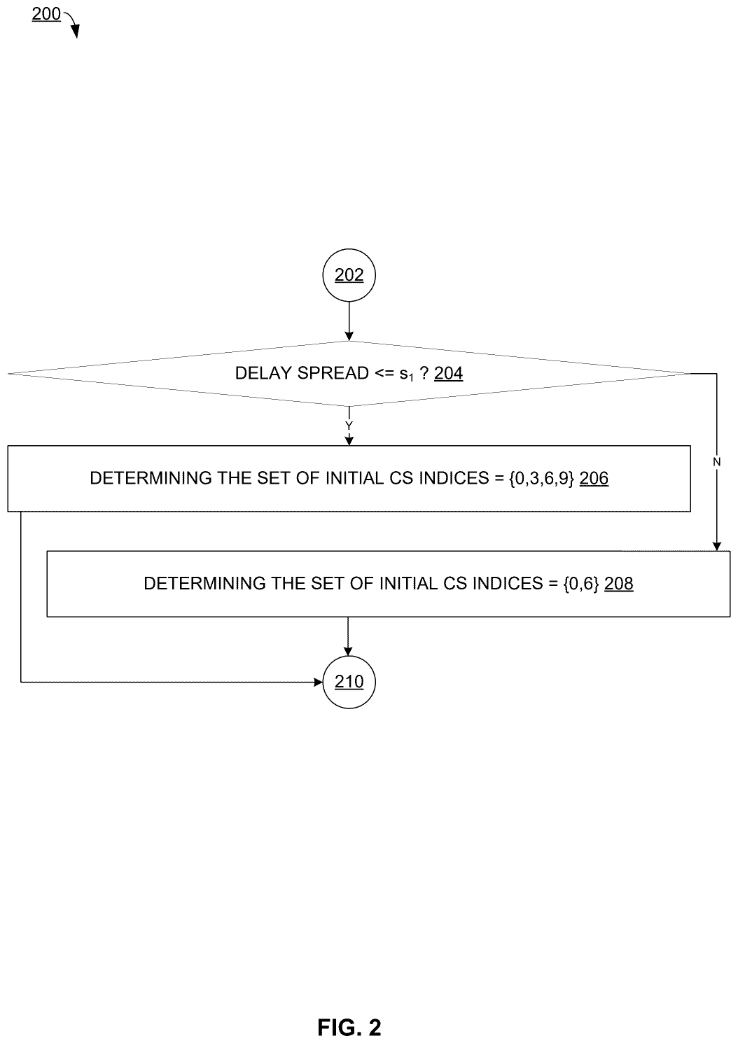

In some examples, dynamic resource configuration in PUCCH component 108 can implement part(s) of the process flows of FIGS. 2-3, 5-6, and/or 8-10 to facilitate dynamic resource configuration in PUCCH.

It can be appreciated that system architecture 100 is one example system architecture for dynamic resource configuration in PUCCH, and that there can be other system architectures that facilitate dynamic resource configuration in PUCCH.

FIG. 2 illustrates an example process flow 200 for determining initial cyclic shift (CS) indices in common PUCCH, and that can facilitate dynamic resource configuration in PUCCH, in accordance with an embodiment of this disclosure. In some examples, one or more embodiments of process flow 200 can be implemented by system architecture 100 of FIG. 1, or computing environment 1100 of FIG. 11.

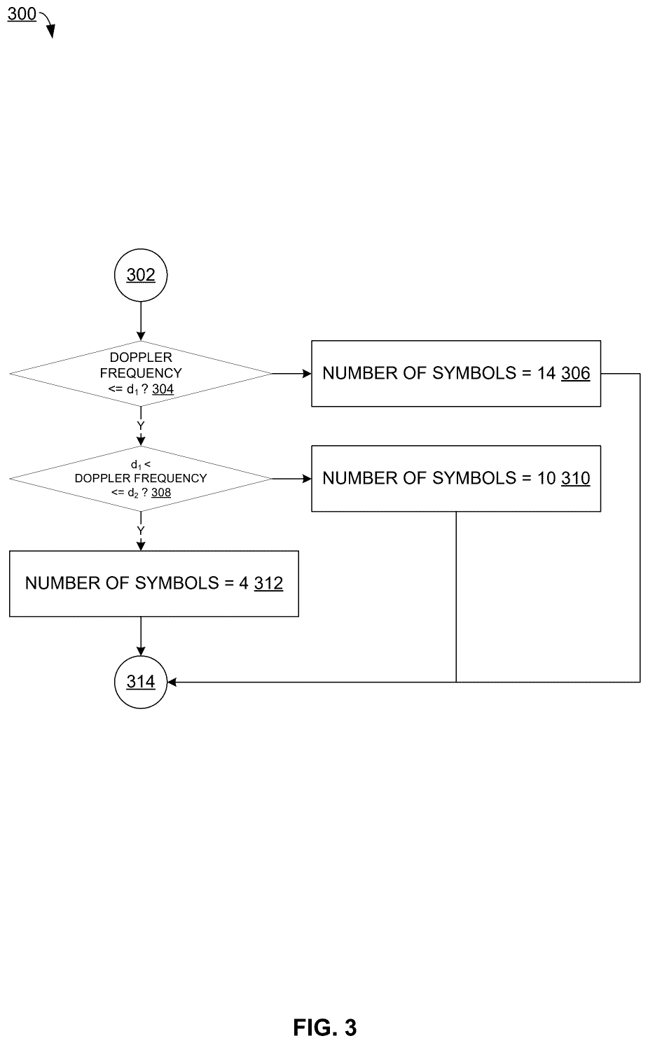

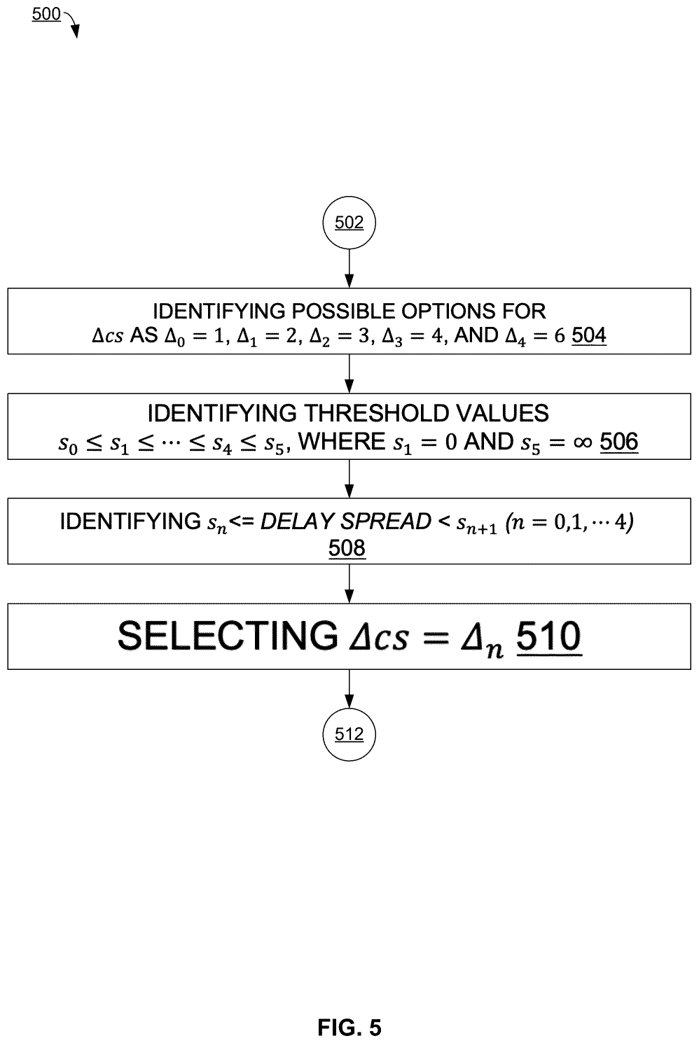

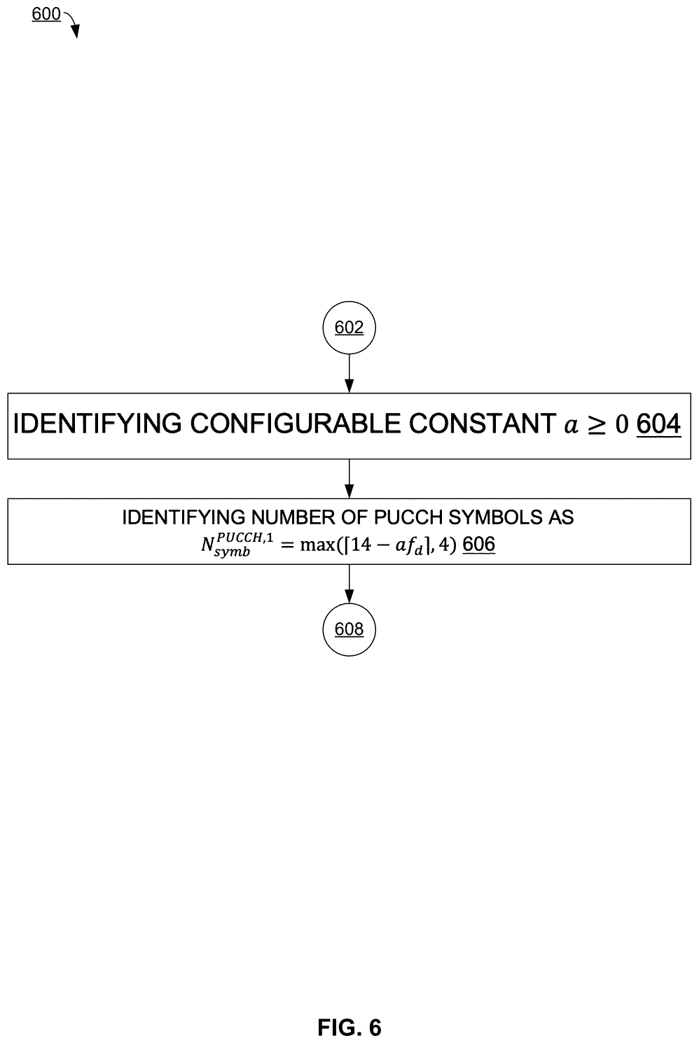

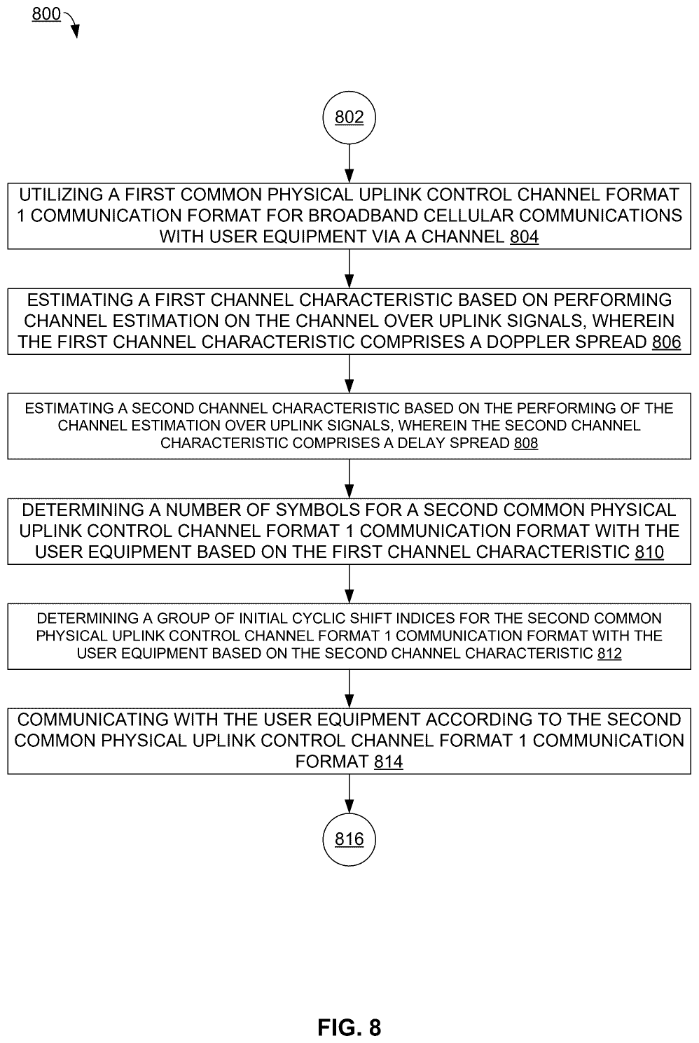

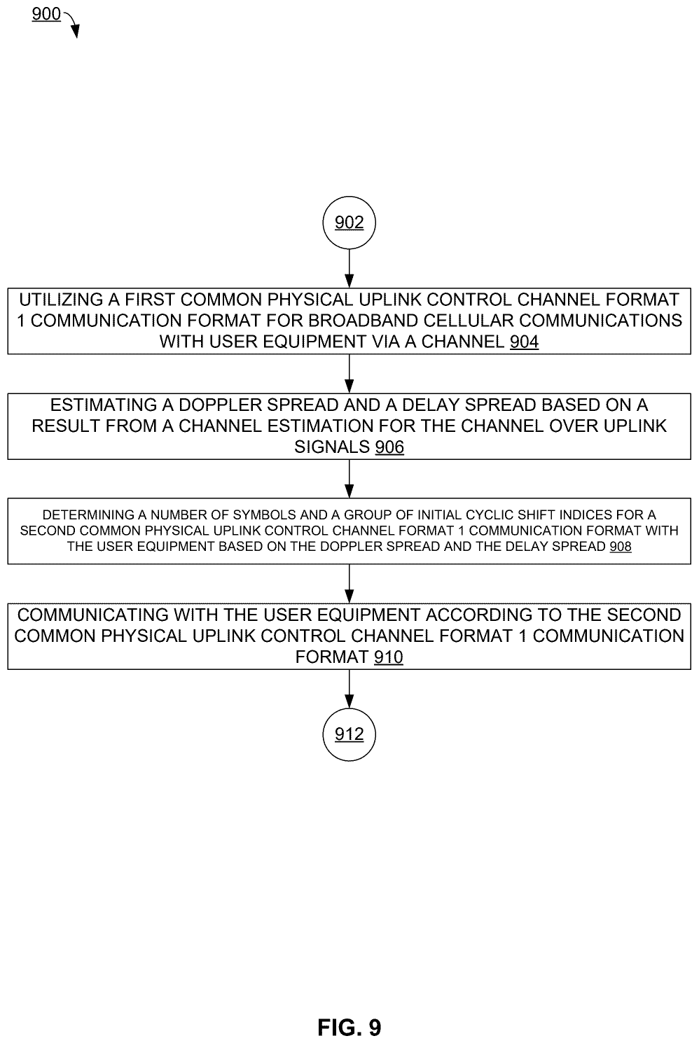

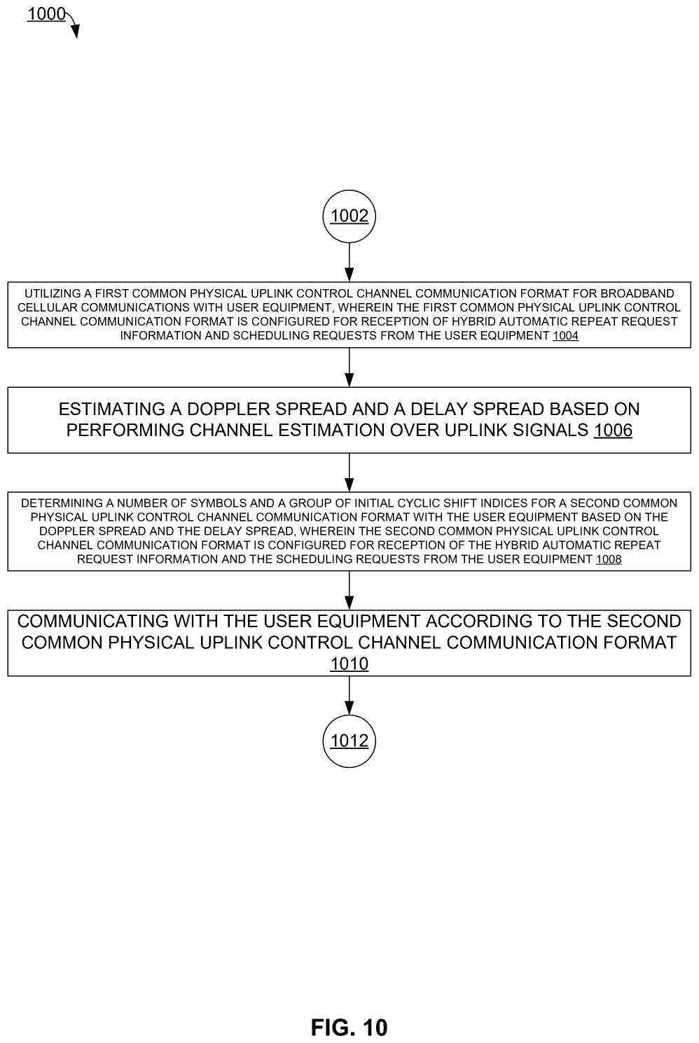

It can be appreciated that the operating procedures of process flow 200 are example operating procedures, and that there can be embodiments that implement more or fewer operating procedures than are depicted, or that implement the depicted operating procedures in a different order than as depicted. In some examples, process flow 200 can be implemented in conjunction with one or more embodiments of process flow 300 of FIG. 3, process flow 500 of FIG. 5, process flow 600 of FIG. 6, process flow 800 of FIG. 8, process flow 900 of FIG. 9, and/or process flow 1000 of FIG. 10.

Process flow 200 begins with 202, and moves to operation 204.

Operation 204 depicts determining whether the delay spread<=s₁. Where it is determined in operation 204 that the delay spread<=s₁, process flow 200 moves to operation 206. Otherwise, process flow 200 moves to operation 208.

Operation 206 is reached from operation 204. Operation 206 depicts determining the set of initial CS indices={0,3,6,9}. After operation 206, process flow 200 moves to 210, where process flow 200 ends.

Operation 208 is reached from operation 204. Operation 206 depicts determining the set of initial CS indices={0,6}. After operation 208, process flow 200 moves to 210, where process flow 200 ends.

With regard to common PUCCH resources, it can be that there are certain options available for PUCCH resource configuration before dedicated PUCCH. The following table can illustrate options for number of symbols, physical resource block (PRB) offset, and a set of initial CS indices. The present techniques can be implemented to choose a number of symbols and a set of initial CS indices according to channel conditions. This can be illustrated in the following pseudocode:

Consider the threshold values s₁, d₁, and d₂, where d₁ < d₂
if delay spread <= s₁
set of initial CS indices = {0,3,6,9}
else
set of initial CS indices = {0,6}
end
if doppler frequency <= d₁
Number of Symbols = 14
elseif d₁ <doppler frequency <= d₂
Number of Symbols = 10
else
Number of Symbols = 4
End

In some examples, the coefficients that are used above such as sᵢ and dᵢ (i=1, 2, . . . ) can be optimized based on the specific receiver algorithm and implementation performance under a given average doppler and delay spreads.

FIG. 3 illustrates an example process flow 300 for determining a number of symbols in common PUCCH, and that can facilitate dynamic resource configuration in PUCCH, in accordance with an embodiment of this disclosure. In some examples, one or more embodiments of process flow 300 can be implemented by system architecture 100 of FIG. 1, or computing environment 1100 of FIG. 11.

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of process flow 200 of FIG. 2, process flow 500 of FIG. 5, process flow 600 of FIG. 6, process flow 800 of FIG. 8, process flow 900 of FIG. 9, and/or process flow 1000 of FIG. 10.

Process flow 300 begins with 302, and moves to operation 304.

Operation 304 depicts determining whether the doppler frequency<=d₁. Where it is determined in operation 304 that the doppler frequency<=d₁, process flow 300 moves to operation 306. Otherwise, process flow 300 moves to operation 308.

Operation 306 is reached from operation 304. Operation 306 depicts setting the number of symbols=14. After operation 306, process flow 300 moves to 314, where process flow 300 ends.

Operation 308 is reached from operation 304. Operation 308 depicts determining whether d₁<doppler frequency<=d₂. Where it is determined in operation 308 that d₁<doppler frequency<=d₂, process flow 300 moves to operation 310. Otherwise, process flow 300 moves to operation 312.

Operation 310 is reached from operation 308. Operation 310 depicts setting the number of symbols=10. After operation 310, process flow 300 moves to 314, where process flow 300 ends.

Operation 312 is reached from operation 308. Operation 312 depicts setting the number of symbols=4. After operation 312, process flow 300 moves to 314, where process flow 300 ends.

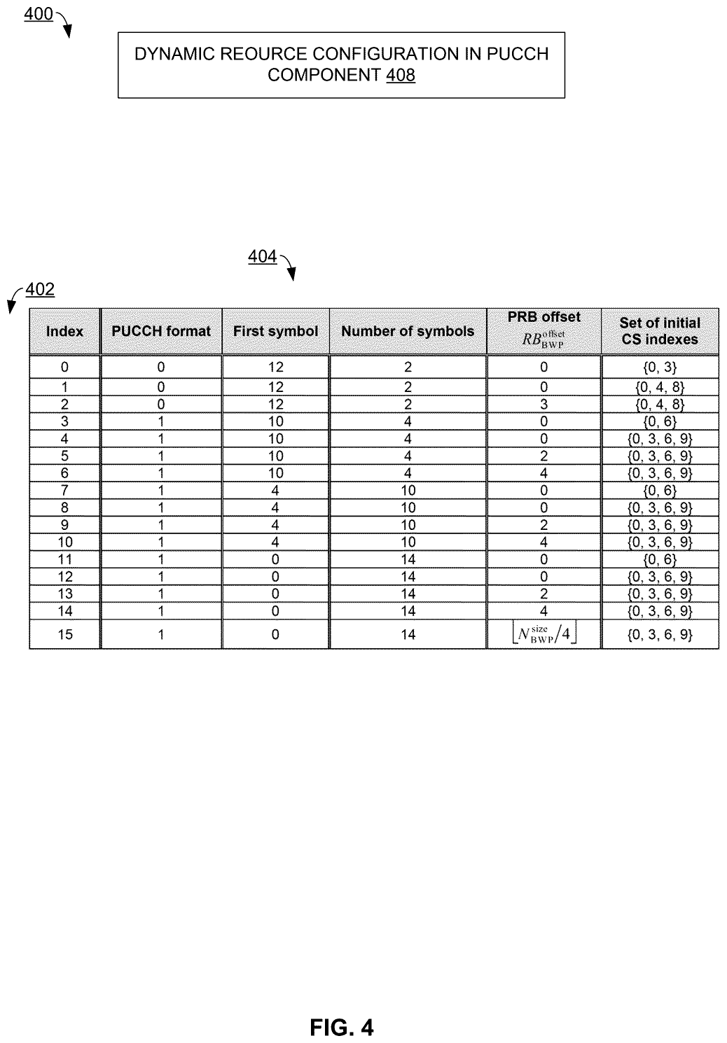

FIG. 4 illustrates an example table 400 that can facilitate dynamic resource configuration in PUCCH, in accordance with an embodiment of this disclosure. In some examples, part(s) of table 400 can be implemented by part(s) of system architecture 100 of FIG. 1 to facilitate dynamic resource configuration in PUCCH.

Table 400 comprises rows 402 and columns 404. Dynamic resource configuration in PUCCH component 408 (which can be similar to dynamic resource configuration in PUCCH component 108 of FIG. 1), can use this information to facilitate dynamic resource configuration in PUCCH.

FIG. 5 illustrates an example process flow 500 for determining CS indices in dedicated PUCCH, and that can facilitate dynamic resource configuration in PUCCH, in accordance with an embodiment of this disclosure. FIG. 5 illustrates another example process flow 500 for dynamic resource configuration in PUCCH, in accordance with an embodiment of this disclosure. In some examples, one or more embodiments of process flow 500 can be implemented by system architecture 100 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow 200 of FIG. 2, process flow 300 of FIG. 3, process flow 600 of FIG. 6, process flow 800 of FIG. 8, process flow 900 of FIG. 9, and/or process flow 1000 of FIG. 10.

Process flow 500 begins with 502, and moves to operation 504.

Operation 504 depicts identifying possible options for Δcs as Δ₀=1, Δ₁=2, Δ₂=3, Δ₃=4, and Δ₄=6.

After operation 504, process flow 500 moves to operation 506.

Operation 506 depicts identifying threshold values s₀≤s₁≤ . . . ≤s₄≤s₅, where s₁=0 and s₅=00.

After operation 506, process flow 500 moves to operation 508.

Operation 508 depicts identifying sₙ<=delay spread<sₙ₊₁ (n=0,1, . . . 4).

After operation 508, process flow 500 moves to operation 510.

Operation 510 depicts selecting Δcs=Δₙ.

After operation 510, process flow 500 moves to 512, where process flow 500 ends.

Dedicated PUCCH can be handled as follows. Dedicated PUCCH resource configuration can be handled in a similar manner as common PUCCH. However, with dedicated PUCCH, it can be that there are more degrees of freedom to be exploited for improving system performance.

A scheduler in a base station can assign a pair of (CS,OCC) to each UE. To do this, the following can be implemented:

A set of CS indices can be chosen. In an example, the possible options for Δcs are Δ₀=1, Δ₁=2, Δ₂=3, Δ₃=4, and Δ₄=6. Consider the threshold values s₀≤ s₁≤ . . . ≤s₄≤s₅, where s₁=0 and s₅=∞. The selection rule for Δcs can be as follows:

If sₙ<=delay spread<sₙ₊₁ (n=0,1, . . . 4), then choose Δcs=Δₙ.

Subsequently, the set of CS indices can be determined based on the selected value of Δcs.

FIG. 6 illustrates an example process flow 600 for determining a number of symbols in dedicated PUCCH, and that can facilitate dynamic resource configuration in PUCCH, in accordance with an embodiment of this disclosure. In some examples, one or more embodiments of process flow 600 can be implemented by system architecture 100 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow 200 of FIG. 2, process flow 300 of FIG. 3, process flow 500 of FIG. 5, process flow 800 of FIG. 8, process flow 900 of FIG. 9, and/or process flow 1000 of FIG. 10.

Process flow 600 begins with 602, and moves to operation 604.

Operation 604 depicts identifying configurable constant a≥0.

After operation 604, process flow 600 moves to operation 606.

Operation 606 depicts identifying number of PUCCH symbols as

$${N}_{sy mb}^{PUCCH , 1} = max ( ⌈ 14 - {af}_{d} ⌉ , 4 ) .$$

After operation 606, process flow 600 moves to 608, where process flow 600 ends.

A number of symbols can be chosen as follows. In an example, the number of symbols for PUCCH Format 1

$$( {N}_{sy mb}^{PUCCH , 1} )$$

can take values in the range [4, 14]. In the presence of doppler frequency, channel variations across time can become larger by increasing the length of an OCC sequence. Hence, interference between OCCs can increase by the length of OCC.

The present techniques can utilize a smaller number of symbols as the doppler frequency increases. Generally, the number of symbols can be defined as a non-increasing function of the doppler frequency. Such a function can be defined for example based on a sequence of thresholds, same as the selection of the set of CS indices above. Another non-increasing function can be a linear function mapped to integer values that are not less than 4. More specifically, for a configurable constant a≥0, the number of PUCCH symbols can be determined as:

$${N}_{sy mb}^{PUCCH , 1} = max ( ⌈ 14 - {af}_{d} ⌉ , 4 )$$

where ┌x┐ is the smallest integer not less than x.

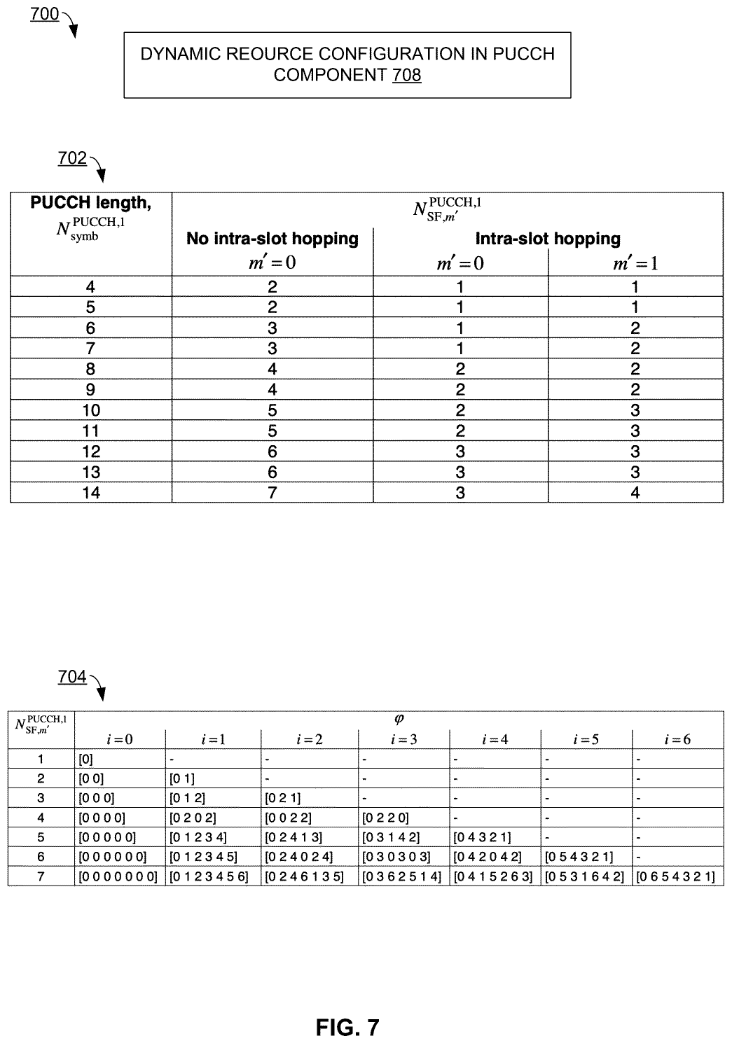

FIG. 7 illustrates an example table 700 for determining an orthogonal cover code (OCC) in dedicated PUCCH, and that can facilitate dynamic resource configuration in PUCCH, in accordance with an embodiment of this disclosure. In some examples, part(s) of table 700 can be implemented by part(s) of system architecture 100 of FIG. 1 to facilitate dynamic resource configuration in PUCCH.

Table 700 comprises table 702 and table 704. Dynamic resource configuration in PUCCH component 708 (which can be similar to dynamic resource configuration in PUCCH component 108 of FIG. 1), can use this information to facilitate dynamic resource configuration in PUCCH.

A set of OCC indices can be chosen as follows. In an example, for any configured

$${N}_{sy mb}^{PUCCH , 1} .$$

the parameter

$${N}_{SF , {m}^{′}}^{PUCCH , 1}$$

can be obtained from table 702. Subsequently for each value of

$${N}_{SF , {m}^{′}}^{PUCCH , 1} ,$$

the set of OCC sequences can be given by table 704. At this stage, L2 can further limit the OCC options (to further reduce the leakage between OCCs). An example approach for choosing a subset of available OCC indices when

$${N}_{SF , {m}^{′}}^{PUCCH , 1}$$

is an even number can be to choose those OCC sequences that are orthogonal to each other in their half-length. For example, for length 6, OCC indices can be obtained as wᵢ(m)=e^{j2πϕ(m)/N}^{_{SF}}, where ϕ(m) can take any of the following options:
ϕ(m)∈{[0,0,0,0,0,0], [0,1,2,3,4,5], [0,2,4,0,2,4], [0,3,0,3,0,3], [0,4,2,0,4,2], [0,5,4,3,2,1]}

It can be that any two OCC sequences derived from these options are orthogonal over their length of 6. However, for the subset
{[0,0,0,0,0,0], [0,2,4,0,2,4], [0,4,2,0,4,2]}

It can be that any pair of OCC sequences are also orthogonal over the first half and second half of the sequence length separately.

Also, for the smaller subset
{[0,0,0,0,0,0], [0,3,0,3,0,3]}
the two OCC sequences can be orthogonal over a third of the sequence length. The OCC sequences obtained from these subsets can be more robust to time variations of the channel as opposed to those in the original set.

### Example Process Flows

FIG. 8 illustrates an example process flow 800 for dynamic resource configuration in PUCCH, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 200 of FIG. 2, process flow 300 of FIG. 3, process flow 500 of FIG. 5, process flow 600 of FIG. 6, process flow 900 of FIG. 9, and/or process flow 1000 of FIG. 10.

Process flow 800 begins with 802, and moves to operation 804.

Operation 804 depicts utilizing a first common physical uplink control channel format 1 communication format for broadband cellular communications with user equipment via a channel. That is, a cell can start with a default or a baseline PUCCH configuration.

After operation 804, process flow 800 moves to operation 806.

Operation 806 depicts estimating a first channel characteristic based on performing channel estimation on the channel over uplink signals, wherein the first channel characteristic comprises a Doppler spread. That is, the present techniques can be based on estimated channel characteristics, including Doppler spread.

In some examples, the performing of the channel estimation over uplink signals comprises determining a physical uplink control channel demodulation reference signal value. In some examples, the performing of the channel estimation over uplink signals comprises determining a physical uplink shared channel demodulation reference signal value. In some examples, the performing of the channel estimation over uplink signals comprises determining a sounding reference signal value. That is channel estimation can be performed over UL signals such as PUCCH DMRS, PUSCH DMRS, and/or SRS.

After operation 806, process flow 800 moves to operation 808.

Operation 808 depicts estimating a second channel characteristic based on the performing of the channel estimation over uplink signals, wherein the second channel characteristic comprises a delay spread. That is, the present techniques can be based on estimated channel characteristics, including delay spread.

In some examples, the Doppler spread comprises an average Doppler spread of multiple ones of the user equipment. In some examples, the Doppler spread comprises respective Doppler spreads of the user equipment. In some examples, the delay spread comprises an average delay spread of multiple ones of the user equipment. In some examples, the delay spread comprises respective delay spreads of the user equipment. That is, the channel characteristics used can include average delay spread or average doppler frequency of all UEs to be scheduled. These channel characteristics can also include separate parameters for each UE.

After operation 808, process flow 800 moves to operation 810.

Operation 810 depicts determining a number of symbols for a second common physical uplink control channel format 1 communication format with the user equipment based on the first channel characteristic. That is, the number of symbols can be chosen an according to Doppler spread of the channel conditions.

After operation 810, process flow 800 moves to operation 812.

Operation 812 depicts determining a group of initial cyclic shift indices for the second common physical uplink control channel format 1 communication format with the user equipment based on the second channel characteristic. That is, the initial CS indices can be chosen an according to delay spread of the channel conditions.

After operation 812, process flow 800 moves to operation 814.

Operation 814 depicts communicating with the user equipment according to the second common physical uplink control channel format 1 communication format. That is, communication with the UE can occur using the number of symbols of operation 810 and the initial CS indices of operation 812.

In some examples, the number of symbols is a first number of symbols, the group of initial cyclic shift indices is a first group of cyclic shift indices, and operation 814 comprises determining a dedicated physical uplink control channel format 1 communication format based on an updated first channel characteristic and an updated second channel characteristic, wherein the dedicated physical uplink control channel format 1 communication format comprises a second number of symbols, and a second group of cyclic shift indices. In some examples, the dedicated physical uplink control channel format 1 communication format comprises orthogonal cover code indices. That is, resource configuration of dedicated PUCCH resources can be performed.

After operation 814, process flow 800 moves to 816, where process flow 800 ends.

FIG. 9 illustrates another example process flow 900 for dynamic resource configuration in PUCCH, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 200 of FIG. 2, process flow 300 of FIG. 3, process flow 500 of FIG. 5, process flow 600 of FIG. 6, process flow 800 of FIG. 8, and/or process flow 1000 of FIG. 10.

Process flow 900 begins with 902, and moves to operation 904.

Operation 904 depicts utilizing a first common physical uplink control channel format 1 communication format for broadband cellular communications with user equipment via a channel. In some examples, operation 904 can be implemented in a similar manner as operation 804 of FIG. 8.

After operation 904, process flow 900 moves to operation 906.

Operation 906 depicts estimating a Doppler spread and a delay spread based on a result from a channel estimation for the channel over uplink signals. In some examples, operation 906 can be implemented in a similar manner as operations 806-808 of FIG. 8.

In some examples, the delay spread comprises a metric of a multipath richness of the channel.

After operation 906, process flow 900 moves to operation 908.

Operation 908 depicts determining a number of symbols and a group of initial cyclic shift indices for a second common physical uplink control channel format 1 communication format with the user equipment based on the Doppler spread and the delay spread. In some examples, operation 908 can be implemented in a similar manner as operations 810-812 of FIG. 8.

In some examples, determining the group of initial cyclic shift indices comprises, based on determining that the delay spread satisfies a threshold criterion, utilizing a first group of initial cyclic shift indices as the group of initial cyclic shift indices, and based on determining that the delay spread fails to satisfy the threshold criterion, utilizing a second group of initial cyclic shift indices as the group of initial cyclic shift indices. This can be implemented in a similar manner as described with respect to FIG. 2.

In some examples, determining the number of symbols comprises, based on determining that the Doppler spread satisfies a first threshold criterion, utilizing a first number of symbols as the number of symbols, based on determining that the Doppler spread fails to satisfy the first threshold criterion and satisfies a second threshold criterion, utilizing a second number of symbols as the number of symbols, and based on determining that the delay spread fails to satisfy the first threshold criterion and the second threshold criterion, utilizing a third number of symbols as the number of symbols. This can be implemented in a similar manner as described with respect to FIG. 3.

After operation 908, process flow 900 moves to operation 910.

Operation 910 depicts communicating with the user equipment according to the second common physical uplink control channel format 1 communication format. In some examples, operation 910 can be implemented in a similar manner as operation 814 of FIG. 8.

After operation 910, process flow 900 moves to 912, where process flow 900 ends.

FIG. 10 illustrates another example process flow 1000 for dynamic resource configuration in PUCCH, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 200 of FIG. 2, process flow 300 of FIG. 3, process flow 500 of FIG. 5, process flow 600 of FIG. 6, process flow 800 of FIG. 8, and/or process flow 900 of FIG. 9.

Process flow 1000 begins with 1002, and moves to operation 1004.

Operation 1004 depicts utilizing a first common physical uplink control channel communication format for broadband cellular communications with user equipment, wherein the first common physical uplink control channel communication format is configured for reception of hybrid automatic repeat request information and scheduling requests from the user equipment. In some examples, operation 1004 can be implemented in a similar manner as operation 804 of FIG. 8.

After operation 1004, process flow 1000 moves to operation 1006.

Operation 1006 depicts estimating a Doppler spread and a delay spread based on performing channel estimation over uplink signals. In some examples, operation 1006 can be implemented in a similar manner as operations 806-808 of FIG. 8.

After operation 1006, process flow 1000 moves to operation 1008.

Operation 1008 depicts determining a number of symbols and a group of initial cyclic shift indices for a second common physical uplink control channel communication format with the user equipment based on the Doppler spread and the delay spread, wherein the second common physical uplink control channel communication format is configured for reception of the hybrid automatic repeat request information and the scheduling requests from the user equipment. In some examples, operation 1008 can be implemented in a similar manner as operations 810-812 of FIG. 8.

After operation 1008, process flow 1000 moves to operation 1010.

Operation 1010 depicts communicating with the user equipment according to the second common physical uplink control channel communication format. In some examples, operation 1010 can be implemented in a similar manner as operation 814 of FIG. 8.

In some examples, operation 1010 comprises determining a group of cyclic shift indices for a dedicated physical uplink control channel format from a finite number of groups of initial cyclic shift indices based on a relationship between a value of the delay spread relative to a finite number of threshold criteria. This can be implemented in a similar manner as described with respect to FIG. 5.

In some examples, the number of symbols is a first number of symbols, and operation 1010 comprises determining a second number of symbols for a dedicated physical uplink control channel format from a finite number of numbers of symbols based on a non-increasing function of a Doppler frequency value. This can be implemented in a similar manner as described with respect to FIG. 6.

In some examples, the number of symbols is a first number of symbols, operation 1010 comprises determining an orthogonal cover code for a dedicated physical uplink control channel format based on a second number of symbols of the dedicated physical uplink control channel format. In some examples, the number of symbols is a first number of symbols, the first number of symbols is an even number, and operation 1010 comprises selecting orthogonal cover code sequences for a dedicated physical uplink control channel format that are orthogonal in half-length. This can be implemented in a similar manner as described with respect to FIG. 7.

In some examples, operation 1010 comprises updating physical uplink control channel resources of the second common physical uplink control channel communication format. That is, the present techniques can improve receiver performance by dynamically selecting the orthogonal sequences for UEs in such a way that those orthogonal sequences with smaller cross correlations are prioritized in being assigned to the UEs. The selection of the resources can be based on channel characteristics learned by a base-station. These characteristics can include average delay spread or average doppler frequency of all UEs to be scheduled. These characteristics can also include separate parameters for each UE.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of base station 102 and/or UEs 104 of FIG. 1.

In some examples, computing environment 1100 can implement one or more embodiments of the process flows of FIGS. 2-3, 5-6, and/or 8-10 to facilitate dynamic resource configuration in PUCCH.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
utilizing a first common physical uplink control channel format 1 communication format for broadband cellular communications with user equipment via a channel;
estimating a first channel characteristic based on performing channel estimation on the channel over uplink signals, wherein the first channel characteristic comprises a Doppler spread;
estimating a second channel characteristic based on the performing of the channel estimation over uplink signals, wherein the second channel characteristic comprises a delay spread;
determining a number of symbols for a second common physical uplink control channel format 1 communication format with the user equipment based on the first channel characteristic;
determining a group of initial cyclic shift indices for the second common physical uplink control channel format 1 communication format with the user equipment based on the second channel characteristic; and
communicating with the user equipment according to the second common physical uplink control channel format 1 communication format.

2. The system of claim 1, wherein the number of symbols is a first number of symbols, wherein the group of initial cyclic shift indices is a first group of cyclic shift indices, and wherein the operations further comprise:
determining a dedicated physical uplink control channel format 1 communication format based on an updated first channel characteristic and an updated second channel characteristic, wherein the dedicated physical uplink control channel format 1 communication format comprises a second number of symbols, and a second group of cyclic shift indices.

3. The system of claim 2, wherein the dedicated physical uplink control channel format 1 communication format comprises orthogonal cover code indices.

4. The system of claim 1, wherein the performing of the channel estimation over uplink signals comprises determining a physical uplink control channel demodulation reference signal value.

5. The system of claim 1, wherein the performing of the channel estimation over uplink signals comprises determining a physical uplink shared channel demodulation reference signal value.

6. The system of claim 1, wherein the performing of the channel estimation over uplink signals comprises determining a sounding reference signal value.

7. The system of claim 1, wherein the Doppler spread comprises an average Doppler spread of multiple ones of the user equipment.

8. The system of claim 1, wherein the Doppler spread comprises respective Doppler spreads of the user equipment.

9. The system of claim 1, wherein the delay spread comprises an average delay spread of multiple ones of the user equipment.

10. The system of claim 1, wherein the delay spread comprises respective delay spreads of the user equipment.

11. A method, comprising:
utilizing, by a system comprising at least one processor, a first common physical uplink control channel format 1 communication format for broadband cellular communications with user equipment via a channel;
estimating, by the system, a Doppler spread and a delay spread based on a result from a channel estimation for the channel over uplink signals;
determining, by the system, a number of symbols and a group of initial cyclic shift indices for a second common physical uplink control channel format 1 communication format with the user equipment based on the Doppler spread and the delay spread; and
communicating, by the system, with the user equipment according to the second common physical uplink control channel format 1 communication format.

12. The method of claim 11, wherein determining the group of initial cyclic shift indices comprises:
based on determining that the delay spread satisfies a threshold criterion, utilizing a first group of initial cyclic shift indices as the group of initial cyclic shift indices; and
based on determining that the delay spread fails to satisfy the threshold criterion, utilizing a second group of initial cyclic shift indices as the group of initial cyclic shift indices.

13. The method of claim 11, wherein determining the number of symbols comprises:
based on determining that the Doppler spread satisfies a first threshold criterion, utilizing a first number of symbols as the number of symbols;
based on determining that the Doppler spread fails to satisfy the first threshold criterion and satisfies a second threshold criterion, utilizing a second number of symbols as the number of symbols; and
based on determining that the delay spread fails to satisfy the first threshold criterion and the second threshold criterion, utilizing a third number of symbols as the number of symbols.

14. The method of claim 11, wherein the delay spread comprises a metric of a multipath richness of the channel.

15. A non-transitory computer-readable medium comprising instructions that, in response to execution, cause a system comprising at least one processor to perform operations, comprising:
utilizing a first common physical uplink control channel communication format for broadband cellular communications with user equipment, wherein the first common physical uplink control channel communication format is configured for reception of hybrid automatic repeat request information and scheduling requests from the user equipment;
estimating a Doppler spread and a delay spread based on performing channel estimation over uplink signals;
determining a number of symbols and a group of initial cyclic shift indices for a second common physical uplink control channel communication format with the user equipment based on the Doppler spread and the delay spread, wherein the second common physical uplink control channel communication format is configured for reception of the hybrid automatic repeat request information and the scheduling requests from the user equipment; and
communicating with the user equipment according to the second common physical uplink control channel communication format.

16. The non-transitory computer-readable medium of claim 15, wherein the operations further comprise:
determining a group of cyclic shift indices for a dedicated physical uplink control channel format from a finite number of groups of initial cyclic shift indices based on a relationship between a value of the delay spread relative to a finite number of threshold criteria.

17. The non-transitory computer-readable medium of claim 15, wherein the number of symbols is a first number of symbols, and wherein the operations further comprise:
determining a second number of symbols for a dedicated physical uplink control channel format from a finite number of numbers of symbols based on a non-increasing function of a Doppler frequency value.

18. The non-transitory computer-readable medium of claim 15, wherein the number of symbols is a first number of symbols, and wherein the operations further comprise:
determining an orthogonal cover code for a dedicated physical uplink control channel format based on a second number of symbols of the dedicated physical uplink control channel format.

19. The non-transitory computer-readable medium of claim 15, wherein the number of symbols is a first number of symbols, wherein the first number of symbols is an even number, and wherein the operations further comprise:
selecting orthogonal cover code sequences for a dedicated physical uplink control channel format that are orthogonal in half-length.

20. The non-transitory computer-readable medium of claim 15, wherein the operations further comprise:
updating physical uplink control channel resources of the second common physical uplink control channel communication format.
